(19) United States
(12) Patent Application Publication
(10) Pub. No.: US 2011/0047485 A1
(43) Pub. Date: Feb. 24, 2011

(54) Information processing apparatus, conference system and information processing method

(75) Inventor: Masaki Takakura, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/805,775

(22) Filed: Aug. 19, 2010

(30) Foreign Application Priority Data
Aug. 20, 2009 (JP) 2009-191257

(51) Int. Cl. G06F 3/01; G06F 15/16

(52) U.S. Cl. 715/753

(57) ABSTRACT

In creating an image in accordance with an operation performed on a shared image, each image is created on an object-by-object basis. In this case, selection of a public mode or a private mode for an other apparatus, i.e., a B terminal apparatus, is received for each object. Information of the selected public or private mode is transmitted to a server apparatus. The other apparatus, i.e., the B terminal apparatus, receives information of an image created by an A terminal apparatus, and displays only an image, with which the information of the public mode is associated, based on the information of the public or private mode included in the received image information.

### CROSS-REFERENCE TO RELATED APPLICATIONS

This Nonprovisional application claims priority under 35 U.S.C. §119(a) on Patent Application No. 2009-191257 filed in Japan on Aug. 20, 2009, the entire contents of which are hereby incorporated by reference.

### BACKGROUND

1. Technical Field

The present invention relates to a conference system capable of implementing a conference among users even when they are at remote sites by sharing sound, video and image among a plurality of information processing apparatuses connected via a network. In particular, the present invention relates to an information processing apparatus, a conference system including a plurality of the information processing apparatuses, and an information processing method, which are capable of allowing a conference participant to write a note, which is visible only to himself or herself, into a shared image by the information processing apparatus used by himself or herself, and thus capable of enhancing usability for the conference participant.

2. Description of Related Art

The advancement of communication technology, image processing technology, etc. has implemented a videoconference capable of allowing conference participants to participate in a conference via a network even when they are at remote sites by using computers. In a videoconference, conference participants are allowed to browse shared document data and the like using a plurality of terminal apparatuses, and an editing/adding process performed on document data is also shared.

Japanese Patent Application Laid-Open No. 2004-317583 proposes a drawing apparatus that retains drawing results, provided by a plurality of terminal apparatuses, on a drawing-layer-by-drawing-layer basis for each terminal apparatus, synthesizes drawing results inputted onto the drawing layers of the respective terminal apparatuses among which the drawing results are shared, and outputs the synthesized result to a common display apparatus. With the use of this drawing apparatus, drawing results provided by the respective terminal apparatuses are outputted to an other apparatus, i.e., the common display apparatus.

Note that an entire editing/adding process performed on shared document data will be shared among a plurality of the terminal apparatuses connected to a videoconference system. However, in some cases, it is unnecessary to share the process that is in progress.

Therefore, Japanese Patent Application Laid-Open No. 2003-281101 relates to an electronic conference system capable of, for example, creating, editing and browsing a shared document, and in particular discloses an invention of an electronic conference system in which a conference participant is allowed to prevent part of document data, which is in the middle of the process of an operation such as addition or editing and is not intended to be seen by other participants, from being shared among all terminals.

### SUMMARY

In some cases, a conference participant not only performs edits on shared document data but also writes a note or the like into shared document data. Notes written into shared document data include: one that should be shared among all participants of a conference system; and one that is intended to be written personally. Therefore, a conference system is desirably configured so that notes, which should be shared, and notes written personally are recognized in a mixed manner on screens of terminal apparatuses individually used by respective conference participants.

However, in principle, notes including edits and additions made to shared document data in a conference system are basically shared among all participants. In order to write a personal note, a conference participant has to separately handwrite a note on a paper medium, for example.

In the drawing apparatus proposed in Japanese Patent Application Laid-Open No. 2004-317583, drawing results such as notes written into shared data by the respective terminal apparatuses can be shared, but the drawing results are separately outputted to the common display apparatus, which means that the drawing apparatus is not configured to synthesize the drawing results and display the synthesized results on the respective terminal apparatuses. When a conference participant wishes to write a note, for example, in response to a note written by the other participant, the conference participant cannot recognize, on a screen of the terminal apparatus used by himself or herself, the note written by the other participant, and therefore, the usability of the drawing apparatus is low. Besides, all notes written by the terminal apparatuses are indiscriminately synthesized on the common display apparatus. That is, for each of contents of notes, no discrimination is made between a note that should be displayed on the common display apparatus, and a note that should be displayed only on the terminal apparatuses individually used by the conference participants.

In the invention disclosed in Japanese Patent Application Laid-Open No. 2003-281101, part of document data, which is not intended to be seen by the other participants, can be prevented from being shared. However, the electronic conference system according to the invention of Japanese Patent Application Laid-Open No. 2003-281101 is configured so that a shared screen display window and an individual screen display window are presented, and information inputted to the individual screen display window is not displayed on the shared screen display window until a sentence termination symbol is inputted. In other words, upon input of a sentence termination symbol, the entire note is shared. The electronic conference system prevents a note, which is still in the middle of an operation, from being shared, but does not allow selection between a note written as a personal note and a note written to be shared among participants. Besides, the electronic conference system is configured so that a note is separately written into the different individual screen display window.

A note written as a personal note is desirably written on a to shared note, for example, but it is insufficient to enhance convenience when it is necessary to separately write a note on a different medium such as paper or to write a note on a different application screen.

Japanese Patent Application Laid-Open No. 11-202997 relates to an information processing apparatus capable of allowing a user to input, via a pen or the like, a note by handwriting so that the inputted note is superimposed on image information such as document data using the information processing apparatus for personal use irrespective of a conference system, and discloses an invention that allows selection between display and non-display of a note written by the user himself or herself because when a pen input is made, the note written by himself or herself interferes with display of normal image information.

The information processing apparatus for personal use according to the invention disclosed in Japanese Patent Application Laid-Open No. 11-202997 allows selection between display and non-display of a note itself written by a user himself or herself, but does not allow selection between display and non-display of a note written on document data shared with other users. The foregoing invention relates to an information processing apparatus for personal use, and therefore cannot display a note, written as a personal note, and a note, written to be shared, in a mixed manner on an image of document data.

The present invention has been made in view of the above-described circumstances, and its object is to provide an information processing apparatus, a conference system including a plurality of the information processing apparatuses, and an information processing method, which are capable of allowing a user who is a conference participant to write a note, which is visible only to himself or herself, onto a shared image by the information processing apparatus used by himself or herself, and thus capable of enhancing usability for each conference participant.

An aspect of the present invention provides an information processing apparatus for receiving image information, displaying, on a display section, a screen including an image provided based on the image information, receiving an operation to create an image in accordance with the operation on an object-by-object basis, storing the image created on an object-by-object basis, together with information indicative of order of superimposition, transmitting image information of the created image to outside, and displaying the created image on the screen, displayed on the display section, in a superimposed manner based on the order of superimposition, the information processing apparatus including: means for receiving a selection of a public mode or a private mode for an other apparatus for each object in creating an image on an object-by-object basis; and means for storing each object of the image in association with public mode enabling/disabling information indicative of the selected public or private mode, wherein the public mode enabling/disabling information is transmitted to outside in a manner that the public mode enabling/disabling information is included in image information of the image.

In the present invention, the screen including an image, which is based on the received image information, is rendered by the information processing apparatus capable of communicating with the other apparatus (external apparatus) such as a server apparatus. Furthermore, an operation is received, an image is created in accordance with the operation for each object such as a rectangle, an ellipse, a polygon or a line, and the created images are stored together with information indicative of the order of superimposition of objects. Then, the image information of the images created on an object-by-object basis is transmitted to the external apparatus, and the created images are displayed in a superimposed manner on the displayed screen. In this case, in the information processing apparatus of the present invention, the selection of the public mode or private mode for the other apparatus for each object is received in creating an image in accordance with an operation, and each object is associated with the public mode enabling/disabling information indicative of the selected public or private mode. When the image information of the created images is transmitted to the other apparatus, the public mode enabling/disabling information is also transmitted by being included in the image information. Thus, the image created in accordance with an operation performed by the information processing apparatus is displayed on the display section of this apparatus, while the public or private mode can be selected for the image for each object on the other apparatus.

Another aspect of the present invention provides the information processing apparatus, wherein the image information including the public mode enabling/disabling information is received from an other apparatus, wherein an image provided based on the received image information is displayed on the screen, wherein whether or not the public mode is selected for each image object of the image information is determined based on the public mode enabling/disabling information included in the received image information, and wherein an image of the object, for which the public mode is determined to be selected, is displayed.

In the present invention, on the screen including the image provided based on the image information received from the server apparatus, the image provided based on the received image information is further displayed. When this image information includes the public mode enabling/disabling information, only the image of the object, with which the public mode enabling/disabling information indicating that the public mode is selected is associated, is displayed based on the public mode enabling/disabling information included in the image information. Thus, the image of the object, for which the private mode is selected by the information processing apparatus, is not displayed on the other information processing apparatus, and the image of the object, for which the public mode is selected, is displayed also on the other information processing apparatus.

Still another aspect of the present invention provides the information processing apparatus including: means for receiving a selection of an image stored on an object-by-object basis; and means for receiving a change of the public or private mode indicated by the public mode enabling/disabling information stored in association with the selected image on an object-by-object basis.

In the present invention, the selection of an image that has already been created on an object-by-object basis is received, and the change of the public or private mode indicated by the public mode enabling/disabling information stored in association with the selected image is received. Thus, even after images have been created, the public or private mode can be selected for the created images on an object-by-object basis.

Yet another aspect of the present invention provides a conference system including: a server apparatus for storing image information; and a plurality of information processing apparatuses capable of communicating with the server apparatus, wherein the server apparatus transmits the stored image information to each information processing apparatus, and each information processing apparatus receives the image information from the server apparatus to display, on a display section, a screen including an image provided based on the image information, receives an operation to create an image in accordance with the operation on an object-by-object basis, stores the image created on an object-by-object basis, together with information indicative of order of superimposition, transmits image information of the created image to the server apparatus, displays the created image on the screen in a superimposed manner based on the order of superimposition, and allows common image information to be displayed on a plurality of the information processing apparatuses so that information is shared among a plurality of the information processing apparatuses, thereby implementing a conference, wherein each information processing apparatus includes: means for receiving a selection of a public mode or a private mode for an other information processing apparatus for each object in creating an image on an object-by-object basis; and means for storing each object of the image in association with public mode enabling/disabling information indicative of the selected public or private mode, wherein the public mode enabling/disabling information is transmitted in a manner that the public mode enabling/disabling information is included in image information of the image, wherein the server apparatus includes: means for storing, when image information is received from each information processing apparatus, the image information for each information processing apparatus serving as a transmission source; means for storing the image information in association with public mode enabling/disabling information included in the received image information; and means for transmitting, to the other information processing apparatus, the image information stored for each information processing apparatus, wherein the public mode enabling/disabling information associated with the image information of the other information processing apparatus is also transmitted to each information processing apparatus, wherein each information processing apparatus further receives image information of an image created by the other information processing apparatus, displays, on the screen, an image provided based on the received image information, and determines, based on the public mode enabling/disabling information included in the received image information, whether or not the public mode is selected for each object of the image in displaying the image, and wherein the image of the object, for which the public mode is determined to be selected, is displayed.

Still yet another aspect of the present invention provides an information processing method for using an information processing apparatus for receiving image information, and for displaying, on a display section, a screen including an image provided based on the image information, the information processing method allowing the information processing apparatus to: receive an operation to create an image in accordance with the operation on an object-by-object basis; store the image created on an object-by-object basis, together with information indicative of order of superimposition; transmit image information of the created image to outside; and display the created image on the screen, displayed on the display section, in a superimposed manner based on the order of superimposition, wherein the information processing apparatus receives a selection of a public mode or a private mode for an other apparatus for each object in creating an image on an object-by-object basis, stores the image in association with public mode enabling/disabling information indicative of the selected public or private mode, and transmits the public mode enabling/disabling information to outside in a manner that the public mode enabling/disabling information is included in image information of the image.

In the present invention, the public or private mode can be selected in displaying, on the other apparatus, an image created in accordance with an operation performed by the information processing apparatus. In the conference system capable of sharing an image, a user can create, on a shared image, any image that is visible only to the user himself or herself and will not be made public on the other apparatus, and can mix these images in a superimposed manner. Using the information processing apparatus of the present invention as the terminal apparatus of the conference system, a conference participant of the conference system can write a note, which is visible only to the conference participant himself or herself, onto a shared image, thus making it possible to enhance usability.

Moreover, in the present invention, an image of an object, for which the public mode is selected by the information processing apparatus, is displayed also on the other apparatus. Using the information processing apparatus of the present invention as the terminal apparatus of the conference system, i.e., using the information processing apparatus as the terminal apparatus by a conference participant himself or herself, for each object such as a line, the conference participant can make a selection between: a note visible only to the conference participant himself or herself; and a note to be shared and shown to the other participant who uses the other apparatus, and furthermore, the notes can be displayed so as to be mixed and superimposed, thus making it possible to enhance usability of the conference system for each conference participant.

Besides, in the present invention, the selection of the public or private mode, received in performing an operation for image creation by the information processing apparatus, can be made for each object even after the image creation. Using the information processing apparatus of the present invention as the terminal apparatus of the conference system, an initially private note can be changed to a note displayed also on the other apparatuses afterward, or conversely, a public note can be changed to a note visible only to a conference participant himself or herself, thus making it possible to further enhance the usability of the terminal apparatus for each conference participant.

The above and further objects and features of the invention will more fully be apparent from the following detailed description with accompanying drawings.

### BRIEF DESCRIPTION OF THE SEVERAL VIEWS OF THE DRAWINGS

FIG. 1 is a diagrammatic representation schematically illustrating a configuration of a conference system according to Embodiment 1;

FIG. 2 is a block diagram illustrating an internal configuration of a terminal apparatus included in the conference system according to Embodiment 1;

FIG. 3 is a block diagram illustrating an internal configuration of a conference server apparatus included in the conference system according to Embodiment 1;

FIG. 4 is an explanatory diagram schematically illustrating how document data is shared among terminal apparatuses of the conference system according to Embodiment 1;

FIG. 5 is an explanatory diagram illustrating an example of a main screen of a conference terminal application, displayed on a display of a terminal apparatus used by a conference participant;

FIG. 6 is a flow chart illustrating an example of a procedure of image creation processing performed by the terminal apparatus included in the conference system according to Embodiment 1;

FIG. 7 is an explanatory diagram illustrating exemplary details of information of created images stored in the terminal apparatuses of the conference system according to Embodiment 1;

FIG. 8 is a flow chart illustrating an example of a procedure of display processing performed by the terminal apparatus included in the conference system according to Embodiment 1;

FIG. 9 is an explanatory diagram illustrating examples of screens obtained as a result of processing performed by the terminal apparatuses of the conference system according to Embodiment 1;

FIG. 10 is an explanatory diagram illustrating exemplary details of image information stored in terminal apparatuses of a conference system according to Embodiment 2;

FIG. 11 is a flow chart illustrating an example of a procedure of processing performed by the terminal apparatus of the conference system according to Embodiment 2;

FIG. 12 is a flow chart illustrating the example of procedure of the processing performed by the terminal apparatus of the conference system according to Embodiment 2; and

FIG. 13 is an explanatory diagram illustrating examples of changes in screens obtained as a result of processing performed by the terminal apparatuses of the conference system according to Embodiment 2.

### DETAILED DESCRIPTION

Hereinafter, the present invention will be specifically described with reference to the drawings illustrating embodiments thereof.

Note that the following embodiments will be described using, as an example, a conference system in which an information processing apparatus of the present invention is used as a terminal apparatus, and sound, video and image are shared by using a plurality of the terminal apparatuses.

### Embodiment 1

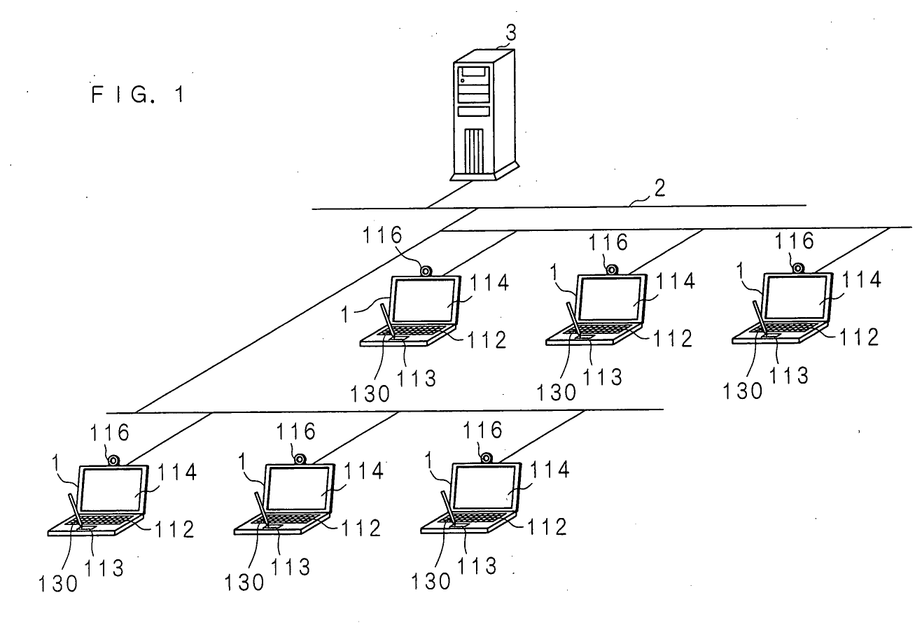

FIG. 1 is a diagrammatic representation schematically illustrating a configuration of a conference system according to Embodiment 1. The conference system according to Embodiment 1 is configured to include: terminal apparatuses 1, 1, . . . used by conference participants; a network 2 to which the terminal apparatuses 1, 1, . . . are connected; and a conference server apparatus 3 for allowing sound, video and image to be shared among the terminal apparatuses 1, 1, . . . .

The network 2, to which the terminal apparatuses 1, 1, . . . and the conference server apparatus 3 are connected, may be an in-house LAN of a company organization in which a conference is held, or may be a public communication network such as the Internet. The terminal apparatuses 1, 1, . . . are authorized to connect with the conference server apparatus 3, and the authorized terminal apparatuses 1, 1, . . . receive/transmit information such as shared sound, video and image from/to the conference server apparatus 3 and output the received sound, video and image, thus allowing the sound, video and image to be shared with the other terminal apparatuses 1, . . . to implement a conference via the network.

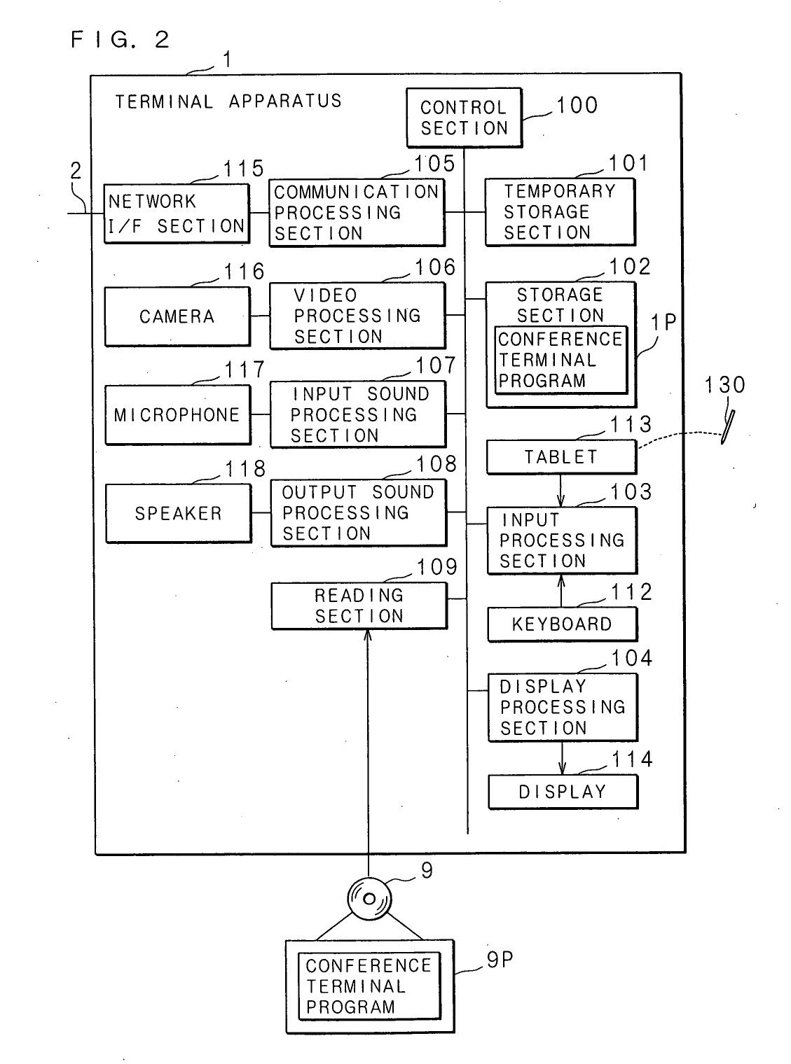

FIG. 2 is a block diagram illustrating an internal configuration of the terminal apparatus 1 included in the conference system according to Embodiment 1.

For the terminal apparatus 1 included in the conference system, a personal computer is used. The terminal apparatus 1 includes: a control section 100; a temporary storage section 101; a storage section 102; an input processing section 103; a display processing section 104; a communication processing section 105; a video processing section 106; an input sound processing section 107; and an output sound processing section 108. Note that the terminal apparatus 1 may be an apparatus used exclusively for a conference terminal. The terminal apparatus 1 further includes a keyboard 112, a tablet 113, a display 114, a network I/F section 115, a camera 116, a microphone 117, and a speaker 118, which may be contained in the terminal apparatus 1 or may be externally connected to the terminal apparatus 1.

For the control section 100, a CPU (Central Processing Unit) is used. The control section 100 loads a conference terminal program 1P, stored in the storage section 102, into the temporary storage section 101, and executes the loaded conference terminal program 1P, thereby operating the personal computer as the information processing apparatus according to the present invention.

For the temporary storage section 101, a RAM such as an SRAM (Static Random Access Memory) or a DRAM (Dynamic Random Access Memory) is used. The temporary storage section 101 stores the conference terminal program 1P loaded as mentioned above, and further stores information generated by processing performed by the control section 100.

For the storage section 102, an external device such as a hard disk or an SSD (Solid State Drive) is used. The storage section 102 stores the conference terminal program 1P. In addition, the storage section 102 may naturally store any other application software program for the terminal apparatus 1.

An input user interface such as an unillustrated mouse or the keyboard 112 is connected to the input processing section 103. In Embodiment 1, the terminal apparatus 1 contains the tablet 113 for receiving an input made by a pen 130, and therefore, the tablet 113 is also connected to the input processing section 103. The input processing section 103 receives information such as button pressing information inputted by an operation performed by a user (conference participant) of the terminal apparatus 1 and/or coordinate information indicative of a position on a screen, and notifies the control section 100 of the received information.

The display 114, for which a liquid crystal display or the like is used, is connected to the display processing section 104. The display 114 may be a touch panel type display containing the foregoing tablet 113. The control section 100 outputs a conference terminal application screen to the display 114 via the display processing section 104, and allows the display 114 to display an image to be shared in the application screen.

For the communication processing section 105, a network card or the like is used. The communication processing section 105 realizes communication performed via the network 2 for the terminal apparatus 1. More specifically, the communication processing section 105 is connected to the network 2 and to the network I/F section 115, divides information, received/transmitted via the network 2, into packets, and reads information from packets, for example. It should be noted that in order to implement the conference system according to Embodiment 1, a protocol such as H.323, SIP (Session Initiation Protocol) or HTTP (Hypertext Transfer Protocol) may be used as a communication protocol for receiving/transmitting an image and a sound by the communication processing section 105. However, the communication protocol to be used is not limited to these protocols.

The video processing section 106 is connected to the camera 116 included in the terminal apparatus 1, controls an operation of the camera 116, and acquires data of video (image) taken by the camera 116. The video processing section 106 may include an encoder, and may perform a process for converting the video, taken by the camera 116, into data conforming to a video standard such as H.264, MPEG (Moving Picture Experts Group).

The input sound processing section 107 is connected to the microphone 117 included in the terminal apparatus 1, and has an A/D conversion function that samples sounds collected by the microphone 117, converts the sounds into digital sound data, and outputs the digital sound data to the control section 100. The input sound processing section 107 may contain an echo canceller.

The output sound processing section 108 is connected to the speaker 118 included in the terminal apparatus 1. The output sound processing section 108 has a D/A conversion function so as to allow sounds to be outputted from the speaker 118 when sound data is supplied from the control section 100.

A reading section 109 is capable of reading information from a recording medium 9 such as a CD-ROM, a DVD, a Blu-ray disc or a flexible disk. The control section 100 stores data, recorded on the recording medium 9, in the temporary storage section 101 or in the storage section 102 via the reading section 109. The recording medium 9 records a conference terminal program 9P for operating a computer as the information processing apparatus according to the present invention. The conference terminal program 1P recorded in the storage section 102 may be a copy of the conference terminal program 9P read from the recording medium 9 by the reading section 109.

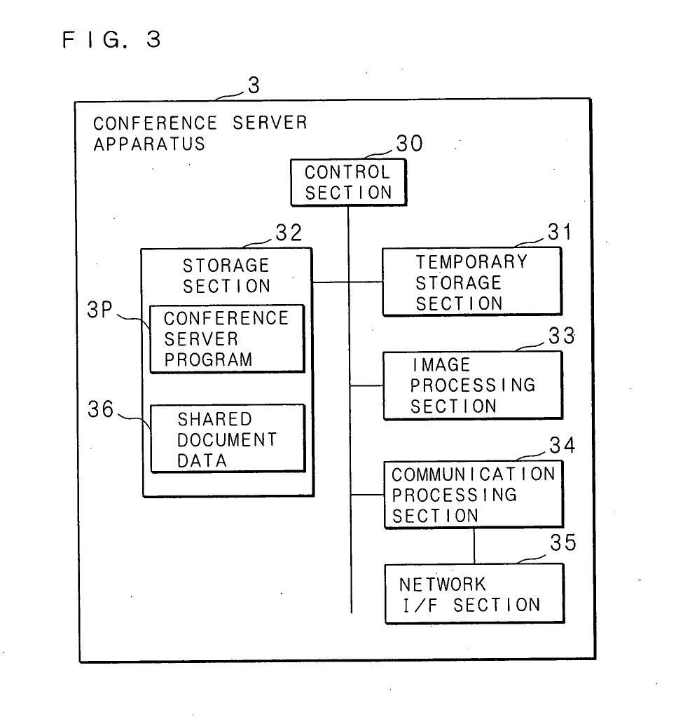

FIG. 3 is a block diagram illustrating an internal configuration of the conference server apparatus 3 included in the conference system according to Embodiment 1.

For the conference server apparatus 3, a server computer is used. The conference server apparatus 3 includes: a control section 30; a temporary storage section 31; a storage section 32; an image processing section 33; and a communication processing section 34, and further contains a network I/F section 35.

For the control section 30, a CPU is used. The control section 30 loads a conference server program 3P, stored in the storage section 32, into the temporary storage section 31, and executes the loaded conference server program 3P, thereby operating the sever computer as the conference server apparatus 3 according to Embodiment 1.

For the temporary storage section 31, a RAM such as an SRAM or a DRAM is used. The temporary storage section 31 stores the conference server program 3P loaded as mentioned above, and temporarily stores after-mentioned image information or the like by processing performed by the control section 30.

For the storage section 32, a hard disk is used. The storage section 32 stores the foregoing conference server program 3P. The storage section 32 further stores authentication data for authenticating the terminal apparatuses 1, 1, . . . used by the conference participants. Moreover, in order to allow shared materials to be displayed on the respective terminal apparatuses 1, 1, . . . in the conference system, the storage section 32 of the conference server apparatus 3 stores a plurality of pieces of document data as shared document data 36. The document data includes text data, photograph data and graphic data, and the format and the like of the document data may be any format.

The image processing section 33 creates an image in accordance with an instruction provided from the control section 30. Specifically, of the shared document data 36 stored in the storage section 32, the document data to be displayed on the respective terminal apparatuses 1, 1, . . . is received by the image processing section 33, and the image processing section 33 converts this document data into an image and outputs the image.

For the communication processing section 34, a network card or the like is used. The communication processing section 34 realizes communication performed via the network 2 for the conference server apparatus 3. More specifically, the communication processing section 34 is connected to the network 2 and to the network I/F section 35, divides information, received/transmitted via the network 2, into packets, and reads information from packets, for example. It should be noted that in order to implement the conference system according to Embodiment 1, a protocol such as H.323, SIP or HTTP may be used as a communication protocol for receiving/transmitting an image and a sound by the communication processing section 34. However, the communication protocol to be used is not limited to these protocols.

The conference participant, participated in an electronic conference with the use of the conference system according to Embodiment 1, utilizes the terminal apparatus 1, and starts up a conference terminal application using the keyboard 112 or the tablet 113 (i.e., the pen 130). Upon start up of the conference terminal application, an authentication information input screen is displayed on the display 114. The conference participant inputs authentication information such as a user ID and a password to the input screen. The terminal apparatus 1 receives the input of the authentication information by the input processing section 103, and notifies the control section 100 of the authentication information. The control section 100 transmits the received authentication information to the conference server apparatus 3 by the communication processing section 105, and receives an authentication result therefrom. In this case, together with the authentication information, information on an IP address allocated to the terminal apparatus 1 is transmitted to the conference server apparatus 3. Thus, the conference server apparatus 3 can identify each of the terminal apparatuses 1, 1, . . . based on its IP address thereafter.

When the conference participant utilizing the terminal apparatus 1 is an authorized person, the terminal apparatus 1 displays a main screen of the conference terminal application, thereby allowing the conference participant to utilize the terminal apparatus 1 as the conference terminal. In this case, when an authorization result indicates that the conference participant is unauthorized, i.e., when the conference participant is a person uninvited to the conference, the terminal apparatus 1 may display, on the display 114, a message saying that the conference participant is unauthorized, for example.

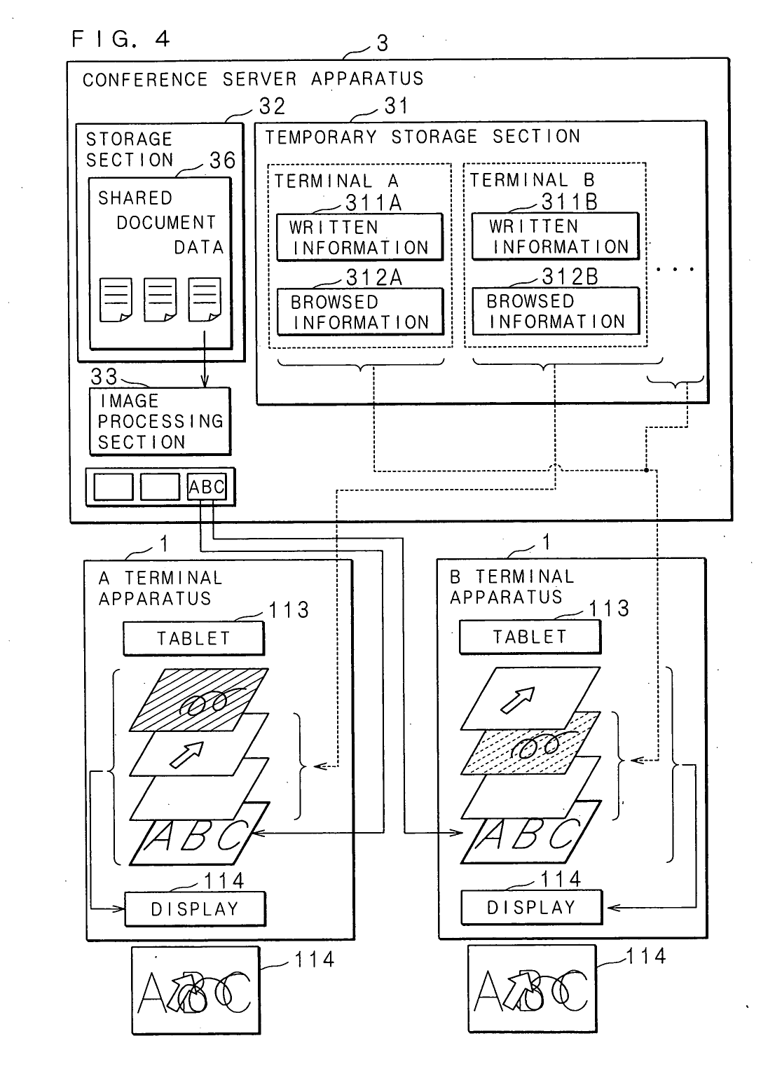

Hereinafter, how the document data is shared among the terminal apparatuses 1, 1, . . . to implement the conference will be described using a schematic diagram. FIG. 4 is an explanatory diagram schematically illustrating how the document data is shared among the terminal apparatuses of the conference system according to Embodiment 1.

The storage section 32 of the conference server apparatus 3 stores the shared document data 36. Of all pieces of the shared document data 36, the shared document data 36 used in the conference is converted into images (imagery) on a page-by-page basis by the image processing section 33. The document data converted into images on a page-by-page basis by the image processing section 33 is received by the terminal apparatuses 1, 1, . . . via the network 2. Note that in order to make a distinction between two of the terminal apparatuses below, one of the terminal apparatuses will be referred to as an “A terminal apparatus 1”, and the other terminal apparatus will be referred to as a “B terminal apparatus 1”.

Each of the A terminal apparatus 1 and the B terminal apparatus 1 receives, from the conference server apparatus 3, the images of the shared document data converted on a page-by-page basis, and outputs the received images from the display processing section 104 so as to display the images on the display 114. In this case, the display processing section 104 draws the image of each page of the shared document data so that the image belongs to a lowermost layer (in bold type) in a displayed screen.

Further, the A terminal apparatus 1 and the B terminal apparatus 1 are each capable of writing a note by the tablet 113 and the pen 130. The control section 100 creates an image in accordance with an input made by the pen 130 via the input processing section 103. The image created by each of the A terminal apparatus 1 and the B terminal apparatus 1 is drawn so that the image belongs to an uppermost layer in the displayed screen.

Furthermore, information of the images created by notes written by the A terminal apparatus 1 and the B terminal apparatus 1 is transmitted as written information to the conference server apparatus 3. Examples of the written information include: the type of the created image for each object; formats such as color, thickness, line type and filling; and coordinate information.

In the conference server apparatus 3, the information of the images, transmitted from the respective terminal apparatuses 1, 1, . . . , is stored as the written information in the temporary storage section 31. The information of the images may be stored in the storage section 32. In Embodiment 1, the information of the images is stored in the storage section 32 at regular time intervals. In this case, the conference server apparatus 3 stores the information of the images transmitted from the respective terminal apparatuses 1, 1, . . . while identifying the respective terminal apparatuses 1, 1, . . . . Referring to FIG. 4, the information of the image created by the A terminal apparatus 1 is stored as written information 311A in association with information (terminal A) by which the A terminal apparatus 1 is identified. Similarly, the information of the image created by the B terminal apparatus 1 is stored as written information 311B in association with information (terminal B) by which the B terminal apparatus 1 is identified.

Then, the written information 311A and 311B stored for each of the terminal apparatuses 1, 1, . . . is transmitted to the different terminal apparatuses 1, 1, . . . by the conference server apparatus 3. In other words, the written information 311A, serving as the information of the image written by the A terminal apparatus 1, is transmitted to the B terminal apparatus 1 from the conference server apparatus 3. Similarly, the written information 311B written by the B terminal apparatus 1 is transmitted to the A terminal apparatus 1 from the conference server apparatus 3.

Based on the written information 311B written by the B terminal apparatus 1 and transmitted from the conference server apparatus 3, the A terminal apparatus 1 creates an image and causes the display 114 to display the created image by the display processing section 104. In this case, the image created based on the written information written by the other terminal apparatus 1 is drawn in a layer located between: the lowermost layer to which the image of each page of the shared document data belongs; and the uppermost layer to which the image written and created by the A terminal apparatus 1 belongs. The same goes for the B terminal apparatus 1.

Thus, as illustrated in a lowermost part of FIG. 4, in each of the A terminal apparatus 1 and the B terminal apparatus 1, the image written by the other one of the terminal apparatuses 1, 1, . . . is displayed over the image of the shared document data, and the image written by the tablet 113 of the A terminal apparatus 1 or the B terminal apparatus 1 itself is displayed on the top.

Further, information indicating the image of which page of which data of the shared document data 36 is displayed (browsed) on each of the terminal apparatuses 1, 1, . . . is stored as browsed information, and is transmitted to the conference server apparatus 3 at regular time intervals. In the conference server apparatus 3, for each of the terminal apparatuses 1, 1, . . . , information indicating the image of which page of which data is displayed is stored as browsed information 312A and 312B in the temporary storage section 31. Note that the browsed information 312A and 312B may be images obtained as a result of superimposition of the layers in the respective terminal apparatuses 1, 1, . . . . The information, indicating which page of which data is displayed on each of the terminal apparatuses 1, 1, . . . , is stored in the conference server apparatus 3, thus also enabling processing such as an operation for synchronously displaying the same page with the same timing on all the terminal apparatuses 1, 1, . . . .

As described above, an image of document data is shared among the respective terminal apparatuses 1, 1, . . . , an image created by one of the terminal apparatus 1 itself is displayed over this image, and an image created by the other one of the terminal apparatuses 1, 1, . . . , used by the other conference participant, is also shared. Accordingly, the conference participants who use the respective terminal apparatuses 1, 1, . . . can browse the same document data, can show notes written by themselves to the other conference participants, and can see notes written by the other conference participants. In this case, the sound data collected by the microphone 117 in each of the terminal apparatuses 1, 1, . . . is also transmitted to the conference server apparatus 3, superimposed by the conference server apparatus 3, transmitted to the respective terminal apparatuses 1, 1, . . . , and outputted from the speaker 118 in each of the terminal apparatuses 1, 1, . . . . Thus, the electronic conference in which materials and sounds are shared can be implemented.

In this case, the conference participant who uses the A terminal apparatus 1 naturally can browse a note, written by himself or herself using the tablet 113, on the display 114, but this note is also transmitted as the written information 311A to the other terminal apparatus, i.e., the B terminal apparatus, via the conference server apparatus 3 and is displayed on the B terminal apparatus. However, notes written by the conference participants include a note written as a personal note.

Therefore, in Embodiment 1, a note, which will not be browsed on the terminal apparatuses 1, 1, . . . used by the other conference participants, is allowed to be written by processing performed mainly by the control section 100, the temporary storage section 101, the storage section 102, the input processing section 103, the display processing section 104 and the communication processing section 105 of each of the terminal apparatuses 1, 1, . . . . Hereinafter, how a note, which will not be browsed on the other terminal apparatuses 1, 1, . . . , is allowed to be written will be described.

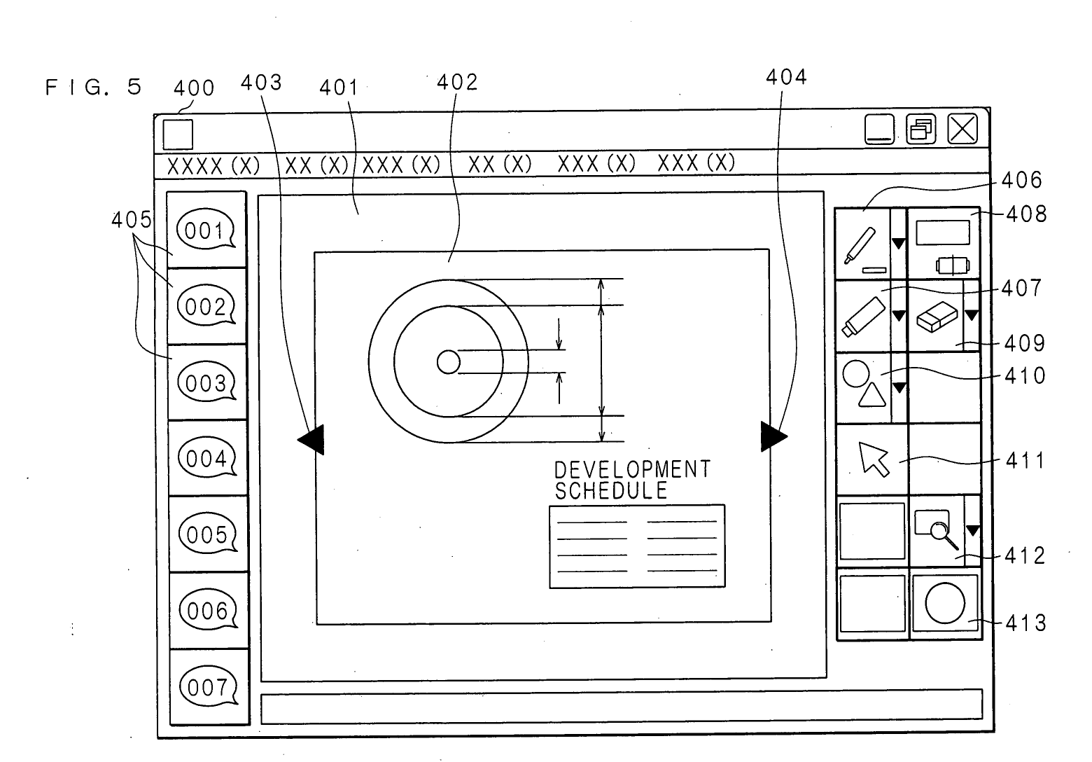

Upon start up of the conference terminal application by the conference participant in the above-described manner, the control section 100 of the terminal apparatus 1 loads the conference terminal program 1P, stored in the storage section 102, to execute the loaded conference terminal program 1P, and then the input screen is first displayed. When the conference participant is authenticated in response to authentication information inputted to the input screen, the control section 100 displays a main screen 400, thereby allowing the conference participant to start utilizing the terminal apparatus 1 as the conference terminal. FIG. 5 is an explanatory diagram illustrating an example of the main screen 400 of the conference terminal application, displayed on the display 114 of the terminal apparatus 1 used by the conference participant.

By way of example, the main screen 400 of the conference terminal application includes, at an approximate center thereof, a shared screen 401 that displays an image of document data to be shared. In the example illustrated in FIG. 5, a document image 402 of the shared document data is reduced in size and contained in the shared screen 401 so that the entire document image 402 is displayed thereon.

At a left end position of an approximate center of the shared screen 401 in its height direction, a preceding page button 403 for providing an instruction for movement to the preceding page of the document data is displayed. Similarly, at a right end position of the approximate center of the shared screen 401 in its height direction, a next page button 404 for providing an instruction for movement to the next page (subsequent page) of the document data is displayed.

When the conference participant who uses the terminal apparatus 1 has performed a click operation while superimposing a pointer of the display 114 over the preceding page button 403 or the next page button 404 using the pen 130 or mouse, for example, an image of the preceding page or next page of the displayed document data is displayed on the shared screen 401.

On the left side of the shared screen 401 in the main screen 400, selection buttons 405 for selecting the other conference participants are displayed. Upon pressing of the selection button 405, display and non-display modes of all notes written by the relevant other conference participant are switched. In the case of the non-display mode, none of the notes written by the relevant other conference participant is displayed. In the case of the display mode, images of the notes written by the relevant other conference participant are displayed except an image of an object for which a private mode is selected as described later.

For example, when the conference participant who uses the terminal apparatus 1 has pressed the selection button 405 of the other conference participant associated with “003” to enter the non-display mode, none of the notes written by the terminal apparatus 1 used by the other conference participant associated with “003” is displayed. To the contrary, only the notes written by the terminal apparatus 1 used by the other conference participant associated with “003” may alternatively be displayed.

On the right side of the shared screen 401 in the main screen 400, various operation buttons for selecting tools during drawing are displayed. The various operation buttons include: a public pen button 406; a secret pen button 407; a color or thickness selection button 408; an eraser button 409; a graphic button 410; a selection button 411; a zoom button 412; and a synchronous/asynchronous button 413.

The public pen button 406 or the secret pen button 407 serves as a button for receiving a selection on whether or not a drawn image (note) is made public on the other terminal apparatuses 1, 1, . . . . With the public pen button 406 or the secret pen button 407 selected, the conference participant who uses the terminal apparatus 1 moves the mouse while clicking the pointer of the display 114, which is superimposed over the shared screen 401 with the use of the mouse or the pen 130, for example, or moves the pen 130 on the tablet, and then free line drawing is enabled on the shared screen 401. Furthermore, upon pressing of the graphic button 410 with the public pen button 406 or the secret pen button 407 selected, drawing of a graphic (such as an ellipse or a polygon) is enabled, and the drawn graphic is made public or kept secret on the other terminal apparatuses 1 in accordance with the type of the selected pen.

Images of free lines and/or graphics created by drawing performed by the conference participant are distinguished from each other on an object-by-object basis. Information of the created images is stored in the temporary storage section 101 together with information indicative of the order of superimposition on an object-by-object basis. Moreover, in association with the foregoing information, information indicating which of a “public pen” and a “secret pen” is selected to draw the image is stored. Then, the information of the images is transmitted to the conference server apparatus 3, and is stored as the written information 311A, 311B, . . . .

It should be noted that as mentioned above, an object such as a free-form curve drawn by an operation, performed by the conference participant who uses the terminal apparatus 1, belongs to the uppermost layer different from the layer including the images of the document data displayed on the shared screen 401.

The color or thickness selection button 408 is a button for receiving a selection of a format such as an image line or filling color, or a line thickness. The conference participant who uses the terminal apparatus 1 performs drawing using a format selected by the color or thickness selection button 408, thereby creating a graphic in the selected format by the control section 100.

The eraser button 409 is a button for receiving erasure of the created image. With the eraser button 409 selected, the participant who uses the terminal apparatus 1 moves the mouse or the pen 130 while clicking the pointer of the display 114, which is superimposed over the displayed image, created by the terminal apparatus 1, with the use of the mouse or the pen 130, for example, and then the displayed image is erased along the pointer.

The graphic button 410 is a button for receiving a selection of an image to be created. The graphic button 410 receives a selection of the type of an image (object) created by the control section 100. For example, the graphic button 410 receives a selection of a graphic such as a circle, an ellipse or a polygon.

The selection button 411 is a button for receiving an operation other than drawing performed by the conference participant. For example, when the selection button 411 is selected, the control section 100 receives, via the input processing section 103, a selection of one of the images that have already been created. With the selection button 411 selected, the conference participant who uses the terminal apparatus 1 moves the mouse while clicking the pointer of the display 114, which is superimposed over the shared screen 401 with the use of the mouse or the pen 130, for example, or moves the pen 130 on the tablet, and then one of the images drawn on the shared screen 401 by the conference participant can be selected on an object-by-object basis.

The zoom button 412 is a button for receiving an enlargement/reduction operation for the image of the document data displayed on the shared screen 401. With the enlargement operation selected, the conference participant clicks the mouse or the pen 130 while superimposing the pointer over the shared screen 401, and then the image of the shared document data and a note written on this image are both displayed in an enlarged manner. A similar process is performed also when the reduction operation is selected.

The synchronous/asynchronous button 413 is a button for receiving a selection on whether or not synchronization is performed so that the displayed image of the document data displayed on the shared screen 401 becomes the same as that of the document data displayed on the particular one of the terminal apparatuses 1, 1, . . . . With synchronization selected, the page of the document data, displayed on the other terminal apparatuses 1, 1, . . . based on the browsed information on the particular terminal apparatus 1, is controlled by the control section 100 based on an instruction provided from the conference server apparatus 3 without reception of an operation for the preceding page, the next page or the like, performed by the conference participant who uses the terminal apparatus 1.

Upon reception of the foregoing operations performed using the various buttons included in the main screen 400, the control section 100 displays, on the shared screen 401, the image of the shared document data 36 received from the conference server apparatus 3, generates an image in accordance with the operations, stores the generated image in the temporary storage section 101, and transmits the generated image to the conference server apparatus 3.

It should be noted that the selection button 405 for each conference participant allows display and non-display to be switched at the receiving terminal apparatus 1 for each of the layers associated with the terminal apparatuses 1, 1, . . . used by the respective conference participants. On the other hand, switching between a public mode and a private mode for an image for each object is performed at the terminal apparatus 1 serving as a transmission source. When the private mode is selected, even if the selection button 405 is selected so as to display a note written by the conference participant who uses the terminal apparatus 1 serving as the transmission source and the note is displayed as an overall layer associated with this terminal apparatus 1, an object of an image included in this layer is not displayed.

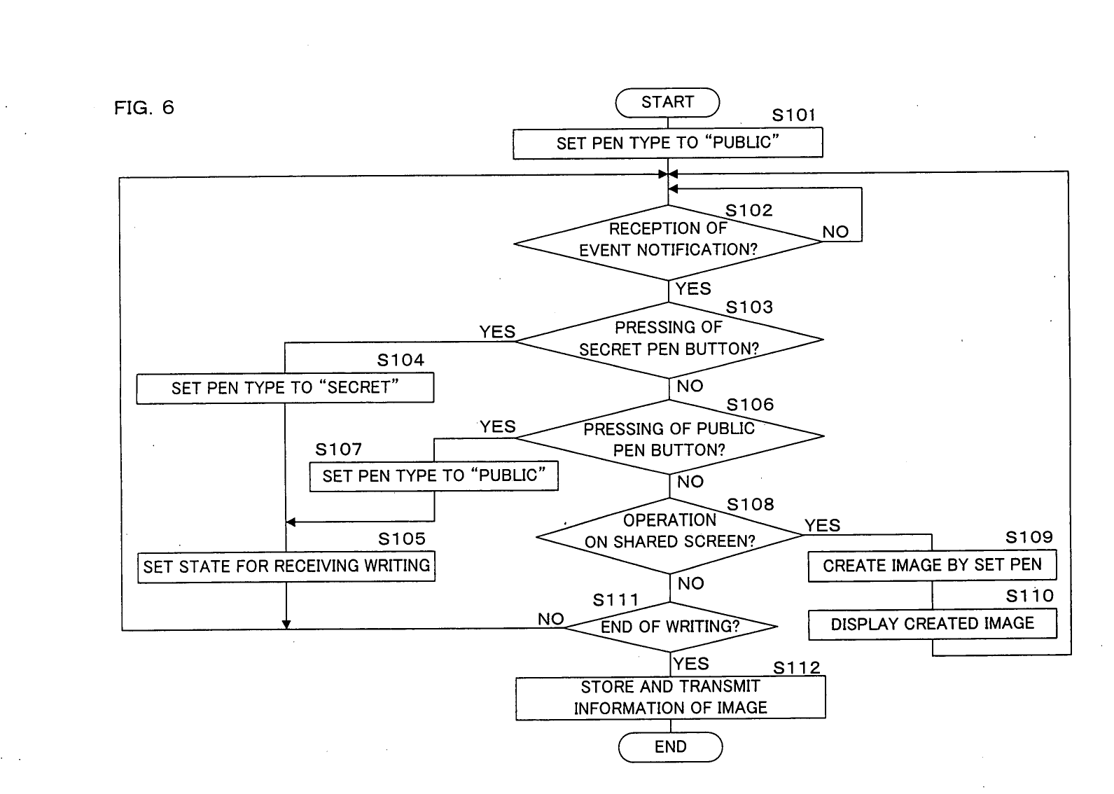

Next, image creation processing performed by the control section 100 in response to an operation carried out by the conference participant will be described with reference to a flow chart. FIG. 6 is a flow chart illustrating an example of a procedure of the image creation processing performed by the terminal apparatus 1 included in the conference system according to Embodiment 1.

With the main screen 400 displayed on the display 114, the control section 100 receives a notification (event notification) that is provided from the input processing section 103 when an operation of some kind is performed by an input device such as the tablet 113 or when the screen is updated by the control section 100 itself, and creates an image in the following processing procedure.

The control section 100 initially sets a pen type for image creation to “public” (Step S101). Then, the control section 100 determines whether or not an event notification is received (Step S102). When it is determined that no event notification is received (S102: NO), the control section 100 returns the procedure to Step S102, and enters a standby state until an event notification is received.

When it is determined that an event notification is received (S102: YES), the control section 100 determines whether or not the received event is pressing of the secret pen button 407 (Step S103). When it is determined that the received event is pressing of the secret pen button 407 (S103: YES), the control section 100 determines that the selection of the “secret pen” is received as the pen type, and sets the pen type for image creation to “secret” thereafter (Step S104). Subsequently, when an operation such as clicking or dragging is performed on the shared screen 401 afterward, the control section 100 sets its mode to a state (writing mode) for receiving the foregoing operation as a writing operation (Step S105), and returns the procedure to Step S102 to enter the standby state until the next event notification is provided.

When it is determined that the received event is not pressing of the secret pen button 407 (S103: NO), the control section 100 determines whether or not the received event is pressing of the public pen button 406 (Step S106). When it is determined that the received event is pressing of the public pen button 406 (S106: YES), the control section 100 determines that the selection of the “public pen” is received as the pen type, and sets the pen type for image creation to “secret” thereafter (Step S107). Subsequently, when an operation is performed on the shared screen 401 afterward, the control section 100 sets its mode to the state (writing mode) for receiving the foregoing operation as a writing operation (Step S105), and returns the procedure to Step S102 to enter the standby state until the next event notification is provided.

When it is determined that the received event is not pressing of the public pen button 406 (S106: NO), the control section 100 determines that the received event is an event other than the selection of the pen. The control section 100 determines whether or not the received event is an operation such as clicking or dragging performed on the shared screen 401 when the state for receiving a writing operation has been set in Step S105 (Step S108). When it is determined in Step S108 that the received event is an operation such as clicking or dragging performed on the shared screen 401 (S108: YES), the control section 100 creates a line and/or a graphic in accordance with the operation (Step S109), and causes the display 114 to display the created line and/or graphic via the display processing section 104 (Step S110). When the control section 100 creates an image in Step S109, the type of the pen used for this image has already been set in Step S104 or 5107. Then, the control section 100 returns the procedure to Step S102, and enters the standby state until the next event notification is subsequently provided.

When it is determined that the received event is an event other than the selection of the pen and is not a drawing operation such as clicking or dragging performed on the shared screen 401 (S108: NO), the control section 100 determines whether or not the received event is an event corresponding to the end of writing, e.g., separation of the pen 130 from the tablet 113, turning OFF of clicking, or pressing of the other button (Step S111).

When it is determined that the received event is not an event corresponding to the end of writing (S111: NO), the control section 100 returns the procedure to Step S102, and enters the standby state until the next event notification concerning writing is provided.

When it is determined that the received event is an event corresponding to the end of writing (S111: YES), the control section 100 stores information such as coordinate information of the image created by the processes of Steps S103 to S110, transmits the information to the conference server apparatus 3 (Step S112), and then ends the processing of image creation corresponding to writing operations.

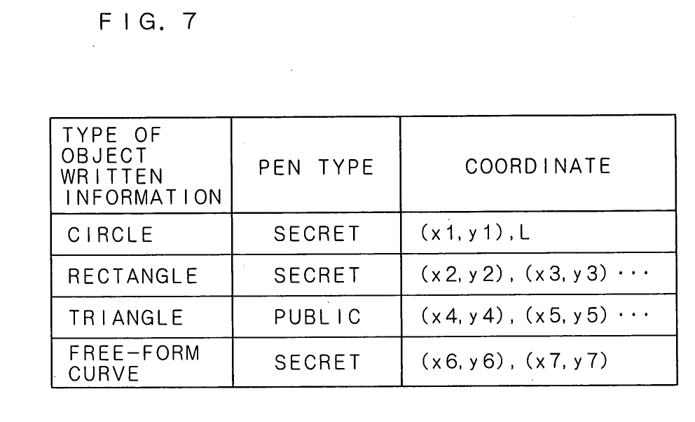

The following description will be made using exemplary pieces of image information on images created in the procedure illustrated in the flow chart of FIG. 6. FIG. 7 is an explanatory diagram illustrating exemplary details of information of created images stored in the terminal apparatuses 1, 1, . . . of the conference system according to Embodiment 1. As illustrated in FIG. 7, the image information includes, on an object-by-object basis, object types, pen types selected in performing drawing, and coordinate information of images. In the examples of FIG. 7, as the object types, a circle (ellipse), a rectangle, a triangle and a free-form curve are provided, and FIG. 7 illustrates a case where the objects other than the triangle object have been created with the secret pen selected. Further, in the examples of FIG. 7, for a circle graphic, coordinate information of a central point and a radius or coordinate information of an upper left vertex and a lower right vertex of a circumscribed rectangle are provided, and for a free-form curve, coordinate information of a plurality of points included in the free-form curve are provided.

Furthermore, the exemplary image information illustrated in FIG. 7 and provided on an object-by-object basis is arranged in the order of superimposition when the order of information sequences is displayed. In other words, the circle, rectangle, triangle and free-form curve in FIG. 7 are superimposed in this order. The rectangle and triangle are displayed over the circle in a superimposed manner, and the free-form curve is displayed on the top. Note that numbers or the like may indicate the order of superimposition, and may be stored in association with the respective objects.

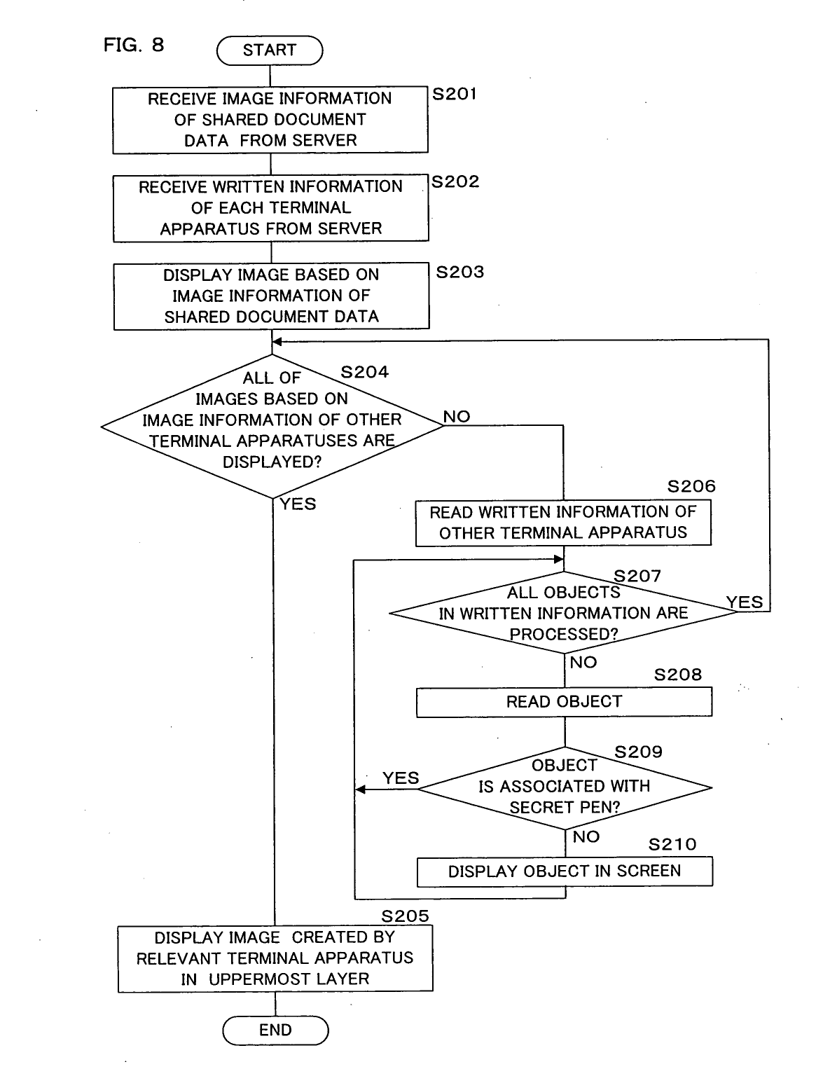

A processing procedure for displaying an image, which has been created and stored as described with reference to FIGS. 6 and 7, on the display 114 will be described below. FIG. 8 is a flow chart illustrating an example of a procedure of display processing performed by the terminal apparatus 1 included in the conference system according to Embodiment 1.

The control section 100 receives image information of shared document data from the conference server apparatus 3 by the communication processing section 105 via the network 2 and the network I/F section 115 (Step S201). Similarly, the control section 100 receives, from the conference server apparatus 3, written information stored for each of the other terminal apparatuses 1, 1, . . . (Step S202). The received written information is stored in the temporary storage section 101. Then, the control section 100 displays, on the shared screen 401 of the main screen 400, an image based on the image information of the shared document data, which has been received in Step S201 (Step S203).

Next, the control section 100 determines whether or not all of images based on the written information of the other terminal apparatuses 1, 1, . . . are displayed (Step S204). When it is determined that all of the images based on the written information of the other terminal apparatuses 1, 1, . . . are displayed (S204: YES), the control section 100 displays an image, created by its own operation, in the uppermost layer located over the image of the shared document data on the shared screen 401 (Step S205), and then ends the procedure.

When it is determined in Step S204 that the image or images based on the written information of one or some of the other terminal apparatuses 1, 1, . . . is/are not displayed (S204: NO), the control section 100 reads the written information of one or some of the other terminal apparatuses 1, 1, . . . (Step S206). The control section 100 determines whether or not processes of Steps S208 to S210 described below are performed on all objects included in the written information (Step S207).

When it is determined that the processes of Steps S208 to S210 are not performed on all the objects (S207: NO), the control section 100 reads objects of images such as those illustrated in FIG. 7 on a one-by-one basis (Step S208), and determines whether or not each of the objects is associated with the “secret pen”, i.e., the private mode for the other apparatus (Step S209).

When it is determined that the object is not associated with the “secret pen” but associated with the “public pen” (Step S209: NO), the control section 100 displays the image of this object over the image of the shared document data on the shared screen 401 (Step S210). In this case, the control section 100 then returns the procedure to Step S207 to determine whether or not all the objects should be displayed.

When it is determined in Step S209 that the object is associated with the “secret pen” (S209: YES), the control section 100 returns the procedure to Step S207 without displaying the image of this object because the private mode is selected for this object on the terminal apparatus 1.

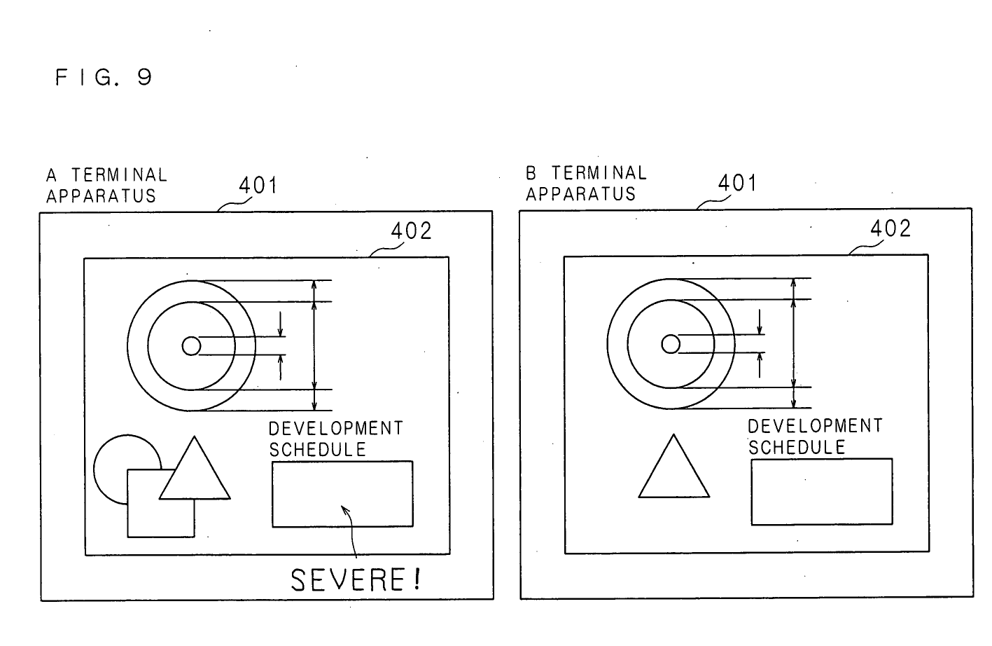

Examples displayed on different terminal apparatuses, i.e., the A terminal apparatus 1 and the B terminal apparatus 1, in the processing procedure illustrated in the flow chart of FIG. 8 will be described below. FIG. 9 is an explanatory diagram illustrating examples of screens obtained as a result of processing performed by the terminal apparatuses 1 of the conference system according to Embodiment 1. It should be noted that the examples illustrated in FIG. 9 are associated with the image information created by the A terminal apparatus 1 and illustrated in FIG. 7.

The shared screen 401 in the main screen 400 of the A terminal apparatus 1 is illustrated at the left side of FIG. 9, and the shared screen 401 of the B terminal apparatus 1 is illustrated at the right side of FIG. 9. On the shared screen 401 of the A terminal apparatus 1 at the left side of FIG. 9, an image of shared document data is displayed in the lowermost layer, and an image drawn by the conference participant who uses this terminal apparatus 1 is displayed over the image of the shared document data. In the example of FIG. 9, a circle, a rectangle and a triangle are displayed in a superimposed manner so that the circle is hidden by the rectangle and the rectangle is hidden by the triangle. Moreover, characters, indicating a region “development schedule” in the image of the shared document data, are created by free-form curves and displayed on the shared screen 401 of the A terminal apparatus 1. In this case, the images other than the triangle are created with the “secret pen” selected as illustrated in FIG. 7. On the A terminal apparatus 1, each of the images is displayed as a written note.

Further, the image information, i.e., the written information (FIG. 7), created by the A terminal apparatus 1 illustrated at the left side of FIG. 9 is transmitted to the conference server apparatus 3, and is stored in the conference server apparatus 3 as the written information 311A in association with the A terminal apparatus 1. Furthermore, the written information 311A is received by the B terminal apparatus 1 as the written information provided from the A terminal apparatus 1.

Also in the B terminal apparatus 1, the processing illustrated in the flow chart of FIG. 8 is performed. In this case, as for the written information provided from the A terminal apparatus 1, the pen type, i.e., whether the image is a public image or a private image, is determined on an object-by-object basis. Then, the image is displayed on the display 114 of the B terminal apparatus 1 only when the image is determined to be a public image. Of the objects of the images created by the A terminal apparatus 1, only the triangle is an object with which the public pen is associated as the pen type. Accordingly, as illustrated at the right side of FIG. 9, only the triangle is displayed on the B terminal apparatus 1, and the image such as a note written using free-form curves and displayed on the A terminal apparatus 1 will not be displayed on the B terminal apparatus 1.

As described above, it can be selected whether the image, created in accordance with an operation performed by each of the terminal apparatuses 1, 1, . . . , should be displayed on the other terminal apparatuses 1, 1, . . . , i.e., whether the image should be made public or kept private. As illustrated in the explanatory diagram of FIG. 9, the conference participant who uses the A terminal apparatus 1 can write a note visible only to himself or herself. Besides, since the images are created on an object-by-object basis and the public or private mode can be selected on an object-by-object basis, the images of public objects and private objects can also be displayed in an overlapped manner on the terminal apparatus 1 used by the conference participant himself or herself. It is unnecessary to perform an operation such as writing of a note into a particular region in the shared screen 401 for only the object to be made public, and the conference participant can superimpose a note over the shared document data without any particular regard thereto by just deciding which image is to be displayed also on the other terminal apparatuses 1, 1, . . . with the selection made for the pen used in creating the image. Note that since a note can also be written into a region other than a region of the image 402 of the shared document data in the shared screen 401, usability is enhanced.

### Embodiment 2

In Embodiment 1, the Conference System is Configured so that the selection of the “public pen” or “secret pen” is enabled at the time of image creation. However, the conference participant might wish to allow an image, which has been shown also on the other terminal apparatuses 1, 1, . . . , to be visible only to himself or herself in an ex-post manner, or the conference participant might wish to do it the other way around. Therefore, in Embodiment 2, the conference system is configured so that the pen type, i.e., the public or private mode, can be changed for each object of a created image in an ex-post manner.

The configuration of the conference system according to Embodiment 2 is similar to that of the conference system according to Embodiment 1 except details of processing for enabling selection of the pen type in an ex-post manner. Accordingly, elements common to Embodiment 1 are identified by the same reference characters, and detailed description thereof will be omitted. Processing steps different from those of Embodiment 1 will be described below.

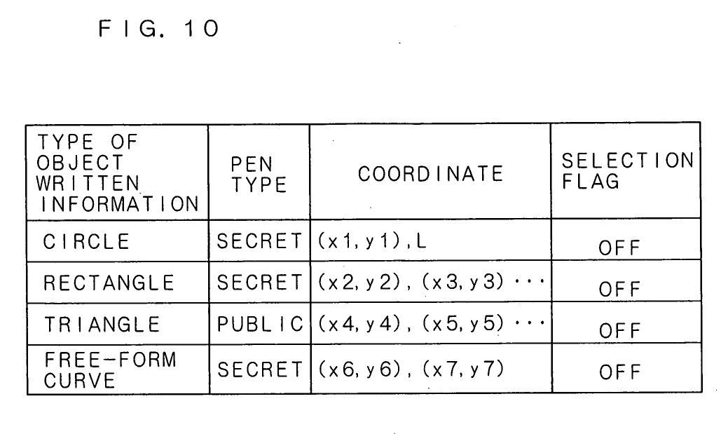

FIG. 10 is an explanatory diagram illustrating exemplary details of image information stored in terminal apparatuses of the conference system according to Embodiment 2. The examples illustrated in FIG. 10 are associated with those of the image information illustrated in FIG. 7. In addition to object types, pen types, coordinate information, and information of the order of superimposition (i.e., the order of the respective objects) for the image information in Embodiment 1, which are illustrated in FIG. 7, information of selection flags is additionally provided in FIG. 10. A selection flag is information set when the selection button 411 is pressed and then an object is selected, and serves as information indicating whether or not an object is selected. When either the public pen button 406 or the secret pen button 407 for selecting the pen type is pressed with the selection flag turned ON, the pen type is changed in accordance with the pressed button. Further, when the selection flag is ON, an image is displayed in a highlighted manner in order to indicate that an object is selected.

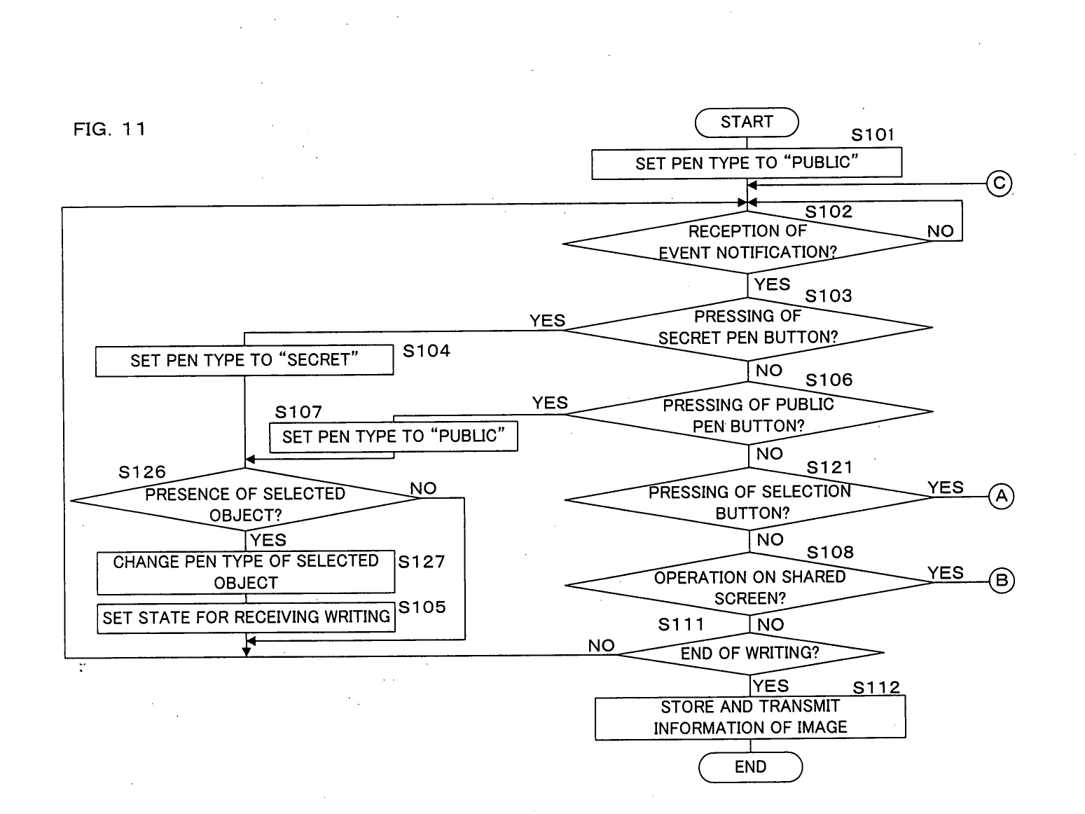

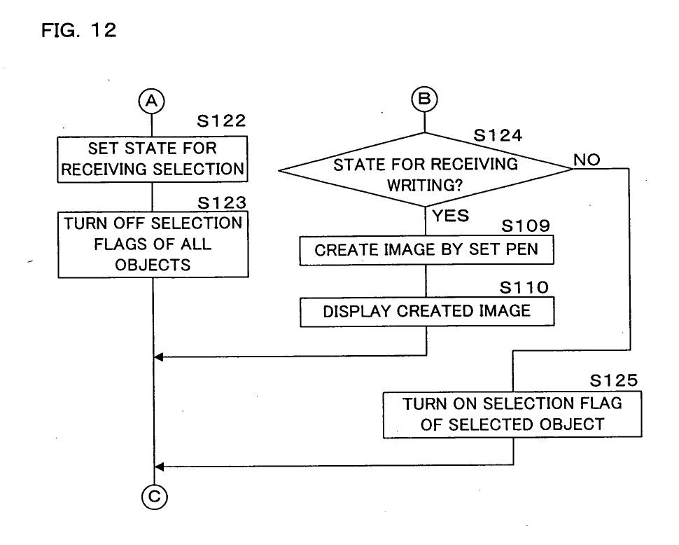

With reference to a flow chart, processing for changing the pen type in an ex-post manner will be described below. FIGS. 11 and 12 are flow charts illustrating an example of a procedure of processing performed by the terminal apparatus 1 of the conference system according to Embodiment 2. The processing illustrated in FIGS. 11 and 12 can be performed along with the steps of selecting the pen type at the time of image creation illustrated in the flow chart of FIG. 6 according to Embodiment 1, and is therefore illustrated in a such a manner that new processing steps are added to FIG. 6. The steps common to those of the processing procedure illustrated in the flow chart of FIG. 6 are identified by the same step numbers, and detailed description thereof will be omitted.

The control section 100 determines whether or not an event notification provided from the input processing section 103 is received (Step S102). When it is determined that an event notification is received (S102: YES), the control section 100 moves the processing to Steps 103 and 106. When it is determined that this event is neither pressing of the secret pen button 407 nor pressing of the public pen button 406 (S103: NO, S106: NO), the control section 100 determines whether or not this event is pressing of the selection button 411 for receiving selection of any one of images that have already been created (Step S121).

When it is determined that the received event is not pressing of the selection button 411 (S121: NO), the control section 100 moves the procedure to Step S108 to determine whether or not the received event is an operation performed on the shared screen 401 (Step S108).

When it is determined that the received event is pressing of the selection button 411 (S121: YES), the control section 100 thereafter sets its mode to a state (selection mode) for receiving selection of any one of the images that have already been created and is displayed on the display 114 of the terminal apparatus used by the conference participant himself or herself (Step S122), and then turns OFF the selection flags of all objects of the stored image information (Step S123). Then, the control section 100 returns the procedure to Step S102, and enters a standby state until the next event notification is provided.

On the other hand, when it is determined that the received event is not pressing of the selection button 411 (S121: NO), the control section 100 moves the procedure to Step S108, and then when it is determined that the received event is an operation performed on the shared screen 401 (S108: YES), the control section 100 determines whether or not the current shared screen 401 has been set to the state (writing mode) for receiving a written note by the process of Step S105 (Step S124). When it is determined that the current shared screen 401 is set to the state for receiving a written note (S124: YES), the control section 100 creates a line and/or a graphic in accordance with an operation (Step S109), and displays the created line and/or graphic on the display 114 (Step S110).

When it is determined that the state (selection mode) for receiving selection is set (Step S124: NO), the control section 100 turns ON the selection flag of an object of an image selected in accordance with an operation (i.e., an image displayed on the top among those containing coordinates when clicking is performed) (Step S125), and then returns the procedure to Step S102 to enter the standby state until the next event notification is provided.

Then, when it is determined that an event notification is received (S102: YES) and it is determined that the received event is pressing of the secret pen button 407 (S103: YES), the control section 100 sets the pen type to the “secret pen” (Step S104), and determines whether or not there is an object selected on the shared screen 401, i.e., there is an object for which the selection flag is ON, at present (Step S126). On the other hand, when it is determined that an event notification is received (S102: YES) and it is determined that the received event is pressing of the public pen button 406 (S106: YES), the control section 100 sets the pen type to the “public pen” (Step S107), and then moves the procedure to Step S126.

When it is determined in Step S126 that there is no selected object (S126: NO), the control section 100 sets the state for receiving a written note (Step S105), and returns the procedure to Step S102.

When it is determined in Step S126 that there is a selected object, i.e., there is an object for which the selection flag is ON (S126: YES), the control section 100 changes the pen type of the object, for which the selection flag is ON, to the set pen type (Step S127).

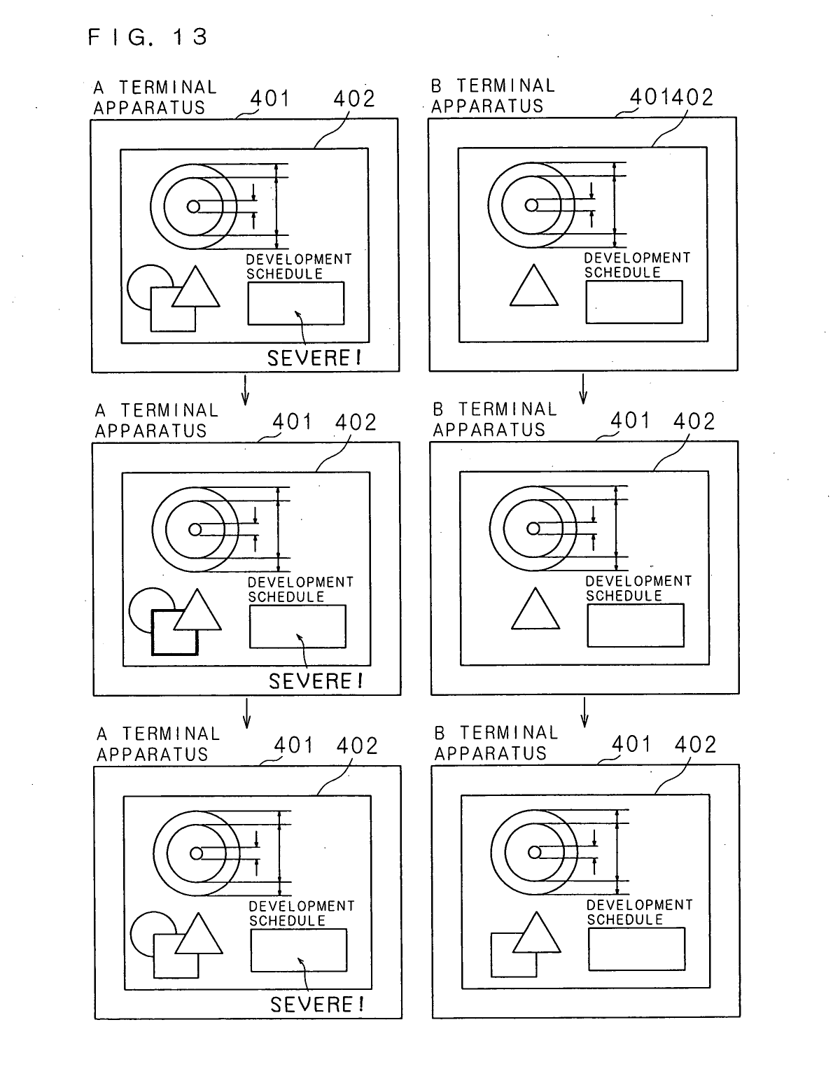

Examples in which pen types are changed in the processing procedure illustrated in the flow charts of FIGS. 11 and 12 will be described below. FIG. 13 is an explanatory diagram illustrating examples of changes in screens obtained as a result of processing performed by the terminal apparatuses 1 of the conference system according to Embodiment 2. The structure of the explanatory diagram of FIG. 13 is similar to that of the diagram of FIG. 9 according to Embodiment 1, and displayed details are changed in accordance with operations from the top to the bottom.

In an upper region of FIG. 13, there is illustrated an example of a screen displayed before the pen type is changed in each of the different terminal apparatuses 1, i.e., the A terminal apparatus 1 and the B terminal apparatus 1. Examples of images displayed in this case are associated with information of images created by the A terminal apparatus 1 and illustrated in FIG. 10. Of the images written by the A terminal apparatus 1, only a triangle image is displayed also on the B terminal apparatus 1.

In a middle region of FIG. 13, there is illustrated an example in which the selection button 411 is pressed and clicking is performed with a pointer located over an object of a rectangle image on the A terminal apparatus 1. In this case, as illustrated in the flow charts of FIGS. 11 and 12, upon determination that the state (selection mode) for receiving selection is set when an operation is performed on the shared screen 401, the control section 100 turns ON the selection flag for the object of the selected image (Step S125). The selection flag for the rectangle object in the image information illustrated in the explanatory diagram of FIG. 10 is turned ON from OFF. In order to allow the grasping of the selected image, the selected image is displayed in a highlighted manner as illustrated in the middle region of FIG. 13.

In a lower region of FIG. 13, there is illustrated an example in which the public pen button 406 is pressed in a state where the object of the rectangle image illustrated in the middle region is selected on the A terminal apparatus 1. In this case, as illustrated in the flow charts of FIGS. 11 and 12, the control section 100 determines that the received event is pressing of the public pen button 406 (S106: YES). Then, the control section 100 sets the pen type to the “public pen” (Step S107), determines that there is a selected object (S126: YES), and changes the pen type for the selected object to the set “public pen” (Step S127). Thus, the pen type for the rectangle object, included in the information of the images created by the A terminal apparatus 1, is changed to the “public pen”. Upon end of a writing operation (S111: YES), information of the image of the rectangle object is also stored and transmitted to the conference server apparatus 3. Also for the written information 311A in the conference server apparatus 3, the pen type for the rectangle object is changed to the “public pen”. Accordingly, when an image created by the A terminal apparatus 1 is displayed on the B terminal apparatus 1 that receives this written information 311A, the rectangle image is also displayed.

As described above, the conference participant can select the public or private mode for a created image for the other apparatus not only at the time of image creation but also after the image creation. Accordingly, an initially private note may be changed to a note displayed also on the other apparatuses afterward, or conversely, a public note may be changed to a note visible only to the conference participant himself or herself. Thus, the usability of the terminal apparatus for each conference participant can be further enhanced.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An information processing apparatus for receiving image information, displaying, on a display section, a screen including an image provided based on the image information, receiving an operation to create an image in accordance with the operation on an object-by-object basis, storing the image created on an object-by-object basis, together with information indicative of order of superimposition, transmitting image information of the created image to outside, and displaying the created image on the screen, displayed on the display section, in a superimposed manner based on the order of superimposition,
the information processing apparatus comprising:
a first reception section for receiving a selection of a public mode or a private mode for an other apparatus for each object in creating an image on an object-by-object basis;
a storage section for storing each object of the image in association with public mode enabling/disabling information indicative of the selected public or private mode; and
a transmission section for transmitting the public mode enabling/disabling information to outside in a manner that the public mode enabling/disabling information is included in image information of the image.

2. The information processing apparatus according to claim 1,
the information processing apparatus further comprising:
a receiving section for receiving the image information including the public mode enabling/disabling information from an other apparatus;
a display control section for displaying, on the screen, an image provided based on the received image information; and
a determination section for determining, based on the public mode enabling/disabling information included in the received image information, whether or not the public mode is selected for each image object of the image information,
wherein the display control section allows display of an image of the object for which the public mode is determined to be selected.

3. The information processing apparatus according to claim 1,
the information processing apparatus further comprising:
a second reception section for receiving a selection of an image stored on an object-by-object basis; and
a third reception section for receiving a change of the public or private mode indicated by the public mode enabling/disabling information stored in association with the selected image on an object-by-object basis.

4. A conference system comprising:
a server apparatus for storing image information; and
a plurality of information processing apparatuses capable of communicating with the server apparatus,
wherein the server apparatus transmits the stored image information to each information processing apparatus, and each information processing apparatus receives the image information from the server apparatus to display, on a display section, a screen including an image provided based on the image information, receives an operation to create an image in accordance with the operation on an object-by-object basis, stores the image created on an object-by-object basis, together with information indicative of order of superimposition, transmits image information of the created image to the server apparatus, displays the created image on the screen in a superimposed manner based on the order of superimposition, and allows common image information to be displayed on a plurality of the information processing apparatuses so that information is shared among a plurality of the information processing apparatuses, thereby implementing a conference,
wherein each information processing apparatus comprises:
a first reception section for receiving a selection of a public mode or a private mode for an other information processing apparatus for each object in creating an image on an object-by-object basis;
a first storage section for storing each object of the image in association with public mode enabling/disabling information indicative of the selected public or private mode; and
a first transmission section for transmitting the public mode enabling/disabling information in a manner that the public mode enabling/disabling information is included in image information of the image,
wherein the server apparatus comprises:
a second storage section for storing, when image information is received from each information processing apparatus, the image information for each information processing apparatus serving as a transmission source;
a third storage section for storing the image information in association with public mode enabling/disabling information included in the received image information;
a second transmission section for transmitting, to the other information processing apparatus, the image information stored for each information processing apparatus; and
a third transmission section for transmitting, to the other information processing apparatus, the public mode enabling/disabling information stored for each information processing apparatus in association with the image information,
wherein each information processing apparatus further comprises:
a receiving section for receiving image information of an image created by the other information processing apparatus;
a display control section for displaying, on the screen, an image provided based on the received image information; and
a determination section for determining, based on the public mode enabling/disabling information included in the received image information, whether or not the public mode is selected for each object of the image in displaying the image, and
wherein the display control section allows display of the image of the object for which the public mode is determined to be selected.

5. The conference system according to claim 4,
wherein each information processing apparatus further comprises:
a second reception section for receiving a selection of an image stored on an object-by-object basis; and
a third reception section for receiving a change of the public or private mode indicated by the public mode enabling/disabling information stored in association with the selected image on an object-by-object basis.

6. An information processing method for using an information processing apparatus for receiving image information, and for displaying, on a display section, a screen including an image provided based on the image information, the information processing method allowing the information processing apparatus to: receive an operation to create an image in accordance with the operation on an object-by-object basis; store the image created on an object-by-object basis, together with information indicative of order of superimposition; transmit image information of the created image to outside; and display the created image on the screen, displayed on the display section, in a superimposed manner based on the order of superimposition,
the information processing method comprising steps of
allowing the information processing apparatus to receive a selection of a public mode or a private mode for an other apparatus for each object in creating an image on an object-by-object basis;
allowing the information processing apparatus to store the image in association with public mode enabling/disabling information indicative of the selected public or private mode; and
allowing the information processing apparatus to transmit the public mode enabling/disabling information to outside in a manner that the public mode enabling/disabling information is included in image information of the image.

7. A recording medium recording a computer program, said computer program comprising steps of
causing a computer, connected so as to be capable of outputting an image to a display section, to receive image information from outside and to display, on the display section, a screen including an image provided based on the received image information;
causing the computer to receive an operation to create an image in accordance with the operation on an object-by-object basis;
causing the computer to store the image created on an object-by-object basis, together with information indicative of order of superimposition;
causing the computer to transmit the created image to outside;
causing the computer to display the created image on the screen, displayed on the display section, in a superimposed manner based on the order of superimposition;
causing the computer to receive a selection of a public mode or a private mode of an image for an other apparatus for each object in creating an image in accordance with the received operation on an object-by-object basis;
causing the computer to store each object of the image in association with public mode enabling/disabling information indicative of the selected public or private mode; and
causing the computer to transmit the public mode enabling/disabling information in a manner that the public mode enabling/disabling information is included in image information of the created image.
